(19) United States
(12) Patent Application Publication
(10) Pub. No.: US 2004/0099516 A1
(43) Pub. Date: May 27, 2004

(54) Electrical switch and method

(76) Inventor: Harry H.J. Bang, Los Angeles, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/713,850

(22) Filed: Nov. 13, 2003

Related U.S. Application Data
(63) Continuation-in-part of application No. 10/302,175, filed on Nov. 21, 2002.

(51) Int. Cl. H01R 13/70

(52) U.S. Cl. 200/51 R

(57) ABSTRACT

A method for providing alternating current electric power to a power consuming device includes moving a first line switch and a second line switch of a switch assembly from open circuit positions to closed circuit positions in a non-simultaneous manner to complete the electrical circuit between the power consuming device and an alternating current power source to avoid harmful sparks. The first line switch and second line switch are respectfully conductively coupled to first and second lines of the electric circuit so that when the first and second line switches are moved to their open circuit positions, no power drain is experienced. A shield may also be disposed between the first line switch and the second line switch for preventing magnetic induction of current.

### RELATED APPLICATION

This application is a Continuation-in-Part of U.S. application Ser. No. 10/302,175, filed Nov. 21, 2002.

### BACKGROUND OF THE INVENTION

The present invention generally relates to electrical switches. More particularly, the invention relates to an energy-saving, dual-line electrical switch that avoids harmful sparking.

It is well-known that a device using electricity for a power source consumes electricity when the device is in operation. However, electric power consumption occurs even when electrical devices are left in an idle operating mode or even switched off due to natural consumption of power by an electrical appliance or device. Natural consumption of electrical power occurs in several ways, one of which is the phenomenon of magnetization that can occur between a bare/uncovered electric wire tip and a metallic plate. Magnetization also occurs when the electric device includes an attached transformer and also bare/uncovered electric wire and metallic plates, various CRT and PCB boards within electric appliances and other various devices found in a modern home.

Therefore, even though an electrical appliance has been turned ‘off’ and the switch is in an ‘off’ position, natural consumption of electric current occurs as long as the device's power cord plug is still connected into an alternating current (AC) power socket.

Generating capacity, dependence on foreign oil, pollution emitted by electric generating plants, global warming, seasonal weather fluctuations affecting home heating/cooling are all issues that affect the cost of electricity. Conservation and reduction of energy consumption are important national and global goals. From a national point of view, huge amounts of money are spent each year paying for electricity which is lost through natural consumption. It is estimated that approximately $10.00 per month per household is paid for electricity lost through natural consumption.

Conventional switches on various electric-powered devices simply turn the appliance on/off by closing/opening a circuit on only one line (i.e, a positive line or a negative (or ground) line). Magnetization will be generated when one line is connected to a transformer or to another part. This magnetization results in the induction of electric current. Not only does this result in consumption of electricity, but also reduces the useful life of electrical parts.

Another problem with electrical switches is that as they are turned on there is the possibility of the creation of a spark. This can be due to the simultaneous electrical connection of the positive and negative connectors or plates. Such sparks can be not only harmful to the user of the power consuming device, but also adversely effect the electronics of the power consuming device due to the spike in electricity or potential fire hazard.

Accordingly, there is a need for an electric switch which prevents the natural consumption of electric current. There is an additional need for a switch will reduce the risk of fires caused from an electrical leakage. Moreover, a switch is needed that will prolong the life of an electric appliance by completely removing the flow of electricity thereto after it is powered off as well as avoiding potentially harmful sparks. The present invention fulfills those needs and provides other related advantages.

### SUMMARY OF THE INVENTION

The switch is designed to prevent natural consumption of electricity, and also prevents magnetic induction of current. This switch may be used in any device that relies on electricity from an AC source. The switch assembly of the present invention also prevents harmful sparking.

A method in accordance with the present invention for providing alternating current electric power to a power consuming device, which is electrically connected to a switch assembly that is, in turn, electrically connected to first and second lines of a power source includes moving a first line switch and a second line switch of the switch assembly from open circuit positions to closed circuit positions in a non-simultaneous manner to complete the electrical circuit between the power consuming device and the source of power while avoiding harmful sparks. Preferably, means are provided for moving the first line switch and the second line switch into open circuit positions in a non-simultaneous manner. The switch assembly may include a main switch electrically connected to the first and second line switches such that when the main switch is open or closed the first and second line switches are also opened and closed in a non-simultaneous manner. In a particularly preferred embodiment, the first line switch and second line switch are magnetically shielded from one another.

The present invention may be embodied in a switch assembly which is adapted to provide the non-simultaneous opening and closing of the first and second line switches. The switch assembly is useful for an alternating current electric circuit having a first line and a second line. The switch has at least two portions: a first line switch and a second line switch. The first line switch is conductively coupled to two separate portions of the first line and movable between an open circuit position and a closed circuit position. The first line switch includes a first connector for connecting the first line switch to a first portion of the first line which is, in turn, connected to a power source. The first line switch also includes a second connector for connecting the first line switch to a second portion of the first line which is, in turn, connected to a power consumer. The first and second portions of the first line are electrically connected when the first line switch is in the closed circuit position and not electrically connected when the first line switch is in the open circuit position.

The second line switch is conductively coupled to two separate portions of the second line and movable between an open circuit position and a closed circuit position. The second line switch includes a first connector for connecting the second line switch to a first portion of the second line which is, in turn, connected to a power source. The second line switch also includes a second connector for connecting the second line switch to a second portion of the second line which is, in turn, connected to a power consumer. The first and second portions of the second line are electrically connected when the second line switch is in the closed circuit position and not electrically connected when the second line switch is in the open circuit position. These connectors may be in the form of screws which connect the first and second lines to their respective line switches.

Means are provided for connecting the first and second line switches to each other such that when the second line switch is moved into a closed circuit position, the first line switch is subsequently moved into its closed circuit position. Alternatively, the means can provide that the second line switch is first moved and the first line switch is subsequently moved into its closed circuit position. Of course, such means can operate in the reverse when opening the circuit. Preferably, the connecting means comprises a mechanical means. Such mechanical means can be incorporated between the main switch and first and second line switches.

Preferably, a compartment is included having a first line switch portion and a second line switch portion. The first line switch is located within the first line switch portion and the second line switch is located within the second line switch portion. Moreover, a shield is provided between the first line switch portion and the second line switch portion for preventing magnetic induction of current.

Other features and advantages of the invention will become more apparent from the following detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a schematic illustration of a switch assembly embodying the present invention in an “off” position;

FIG. 2 is a schematic illustration of the switch assembly of FIG. 1, illustrating a main switch thereof intermediate the “on” and “off” positions;

FIG. 3 is a schematic illustration similar to FIG. 1 of the switch assembly, illustrating the switch in the “on” position;

FIG. 4 is another schematic illustration of a switch assembly embodying the present invention in an “off” position;

FIG. 5 is a schematic illustration of the switch assembly of FIG. 4 in an intermediate position;

FIG. 6 is a schematic illustration, illustrating the switch in the “on” position;

FIG. 7 is a schematic illustration of a plug-in wall unit switch assembly embodying the present invention in an “off” position;

FIG. 8 is a schematic illustration of the plug-in switch assembly of FIG. 7 in an intermediate position; and

FIG. 9 is a schematic illustration of the plug-in switch assembly in an “on” position.

### DETAILED DESCRIPTION OF THE PREFERRED EMBODIMENTS

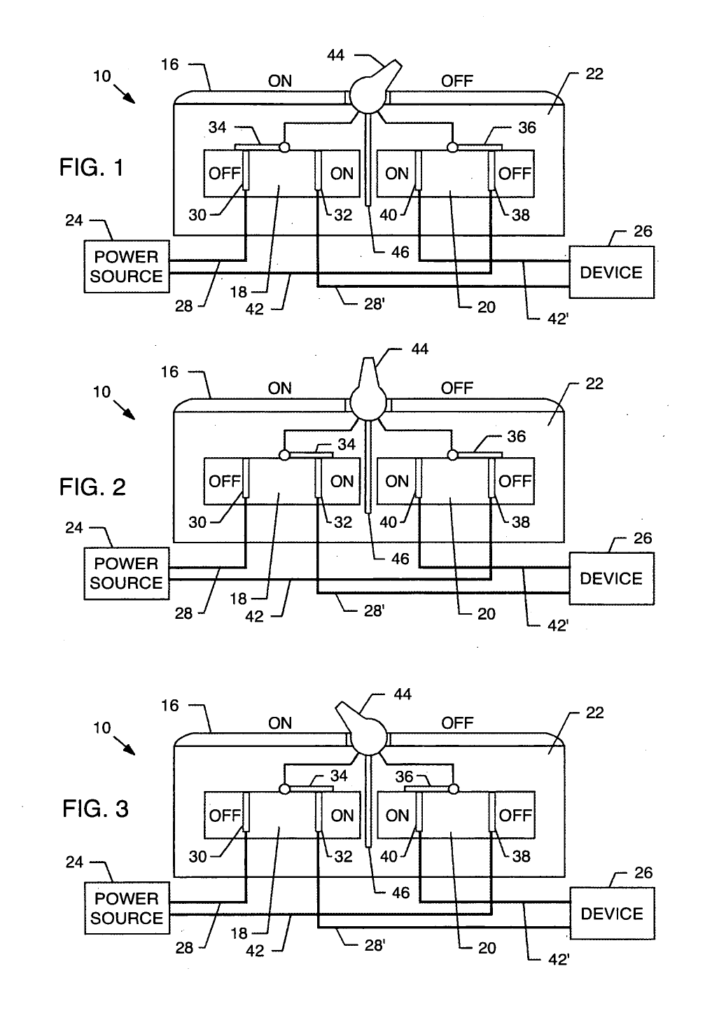

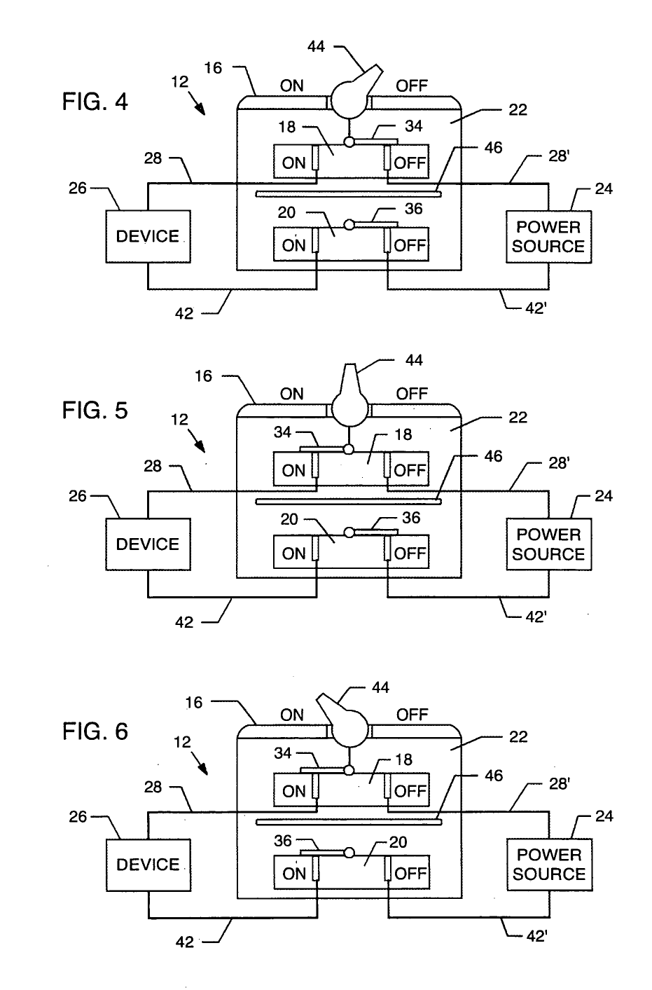

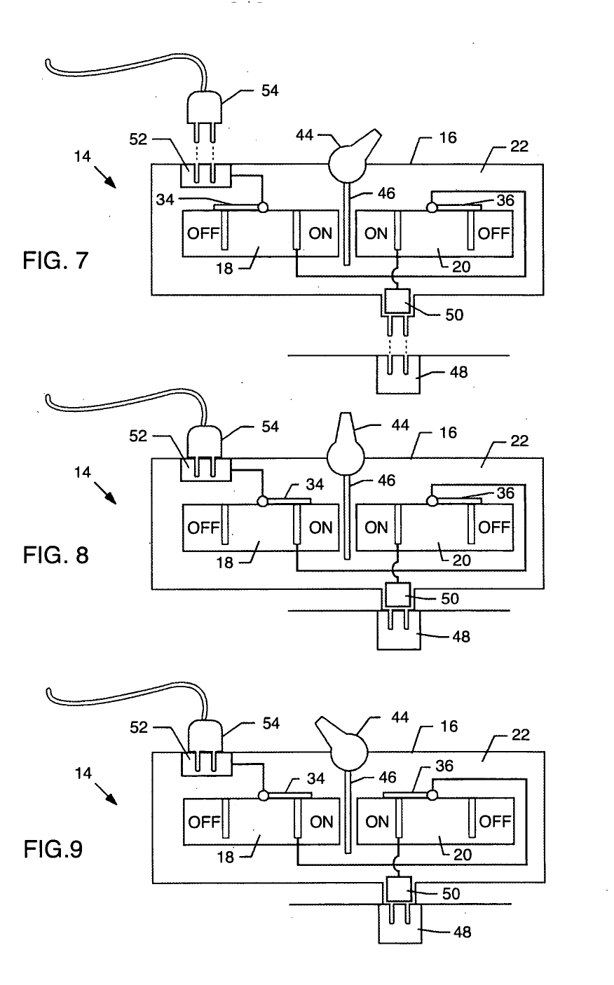

As shown in the accompanying drawings for purposes of illustration, the present invention resides in a switch assembly, referred to by the reference number 10 in FIGS. 1-3, by the reference number 12 in FIGS. 4-6, and by the reference number 14 in FIGS. 7-9. The switch assemblies 10-14 are designed such so that power is provided to an electrical power consuming device in a staggered manner so as to prevent sparks and the accompanying dangers associated therewith. Also, the electrical switch assemblies 10-14 have shielding means such that magnetic induction is eliminated, thus eliminating the power drain prevalent in many existing switches and devices.

With reference now to FIGS. 1-3, a first exemplary embodiment of the electrical switch assembly 10 of the present invention is shown in a schematic form. The assembly 10 includes a housing 16 which houses a first line switch 18 and a second line switch 20 within a compartment 22 thereof. The first and second line switches 18 and 20 are conductively coupled to a power source 24 and a power consuming device 26.

The first line switch 18 includes a first connector, such as a conductive screw, compression connector, soldering or any other connector well-known in the art for connecting the switch 18 to a first portion 28 of a first line. The line switch 18 includes another electrical connector which connects the switch 18 to a second portion 28′ of the first line. For example, as illustrated, the first portion 28 of the first electrical line may extend between the power source 24 and a conductive coupling/connector of the switch 18. The second portion 28′ of the first line extends between a second electrical connector switch 18 and the power consuming device 26.

The first line switch 18 includes a conductive switch portion 34 which is physically movable between the first and second electrical connections 30 and 32 so as to open the circuit in the “off” position, as illustrated in FIG. 1, or in the closed circuit “on” position, as illustrated in FIGS. 2 and 3. Moving the switch element 34 to the “on” position closes the circuit between the power source 24 and the device 26 with respect to the first line 28 and 28′.

Similarly, the second switch 20 includes a switch element 36 which is moved between electrical connectors 38 and 40. The first electrical connector 38 connectively couples the second switch 20 to the power source 24 by means of a first portion 42 of a second line. The second electrical connector 40 connects the switch 20 to a second portion of the second line 42′ which extends between the switch 20 and the electrical consuming device 26. Once again, the switch element is movable between the open circuit, “off” position, illustrated in FIGS. 1 and 2 to the closed circuit “on” position as illustrated in FIG. 3 so as to close the circuit and provide power through the second line 42 and 42′ from the power source 24 to the electrical device 26.

An important aspect of the present invention is that the assembly 10 is adapted such so that the first and second line switches 18 and 20 are moved from their open circuit positions to their closed circuit positions, or vice versa, in a non-simultaneous manner so as to be staggered and avoid harmful sparking. As illustrated in FIG. 1, both the first and second line switches 18 and 20 are in their open circuit or “off” positions. In order to provide power from the power source 24 to the electrical consuming device 26, the electrical switch element 34 or 36 of the first or second line switch 18 and 20 is first moved into the closed circuit or “on” position. As illustrated in FIG. 2, the first line switch element 34 is moved from the “off” or open circuit position to the “on” or closed circuit position such that the first line is conductively coupled between the power source 24 and the electrical device 26. As illustrated in FIG. 3, the second line switch 20 is then actuated such that the second switch element 36 is moved from the open circuit or “off” position, illustrated in FIGS. 1 and 2, to the closed circuit or “on” position, as illustrated in FIG. 3 to complete the electrical circuit and provide alternating current through the first and second lines 28 and 42 from the power source 24 to the power consuming device 26. By staggering these positions, harmful sparks are avoided.

In a particularly preferred embodiment, the assembly 10 includes a main switch 44 which is mechanically coupled to the first and second line switches to actuate them. Any conventional mechanical means, such as gears, levers, mechanical switches, etc. can be employed such that as the main switch 44 is moved from the open circuit “off” position, as illustrated in FIG. 1, to the closed circuit “on” position, illustrated in FIG. 3, that the first and second line switches 18 and 20 are similarly moved from the open circuit “off” position to the closed circuit “on” position in a non-simultaneous manner, as described above. Although the main switch 44 is illustrated in the figures as a toggle-type switch, it will be appreciated by those skilled in the art that the switch can in fact be embodied in other forms such as by push-button switch, revolving switch, push-to-level switch, pull-string switch, etc.

With continuing reference to FIGS. 1-3, in a particularly preferred embodiment a shield 46 is disposed between the first and second line switches 18 and 20. The shield 46 essentially divides the compartment 22 into two separate compartments, each compartment housing either the first line switch 18 or second line switch 20. The shield 46 serves to block and prevent magnetic induction of current and consumption of electricity which would otherwise occur even when the first and second lines 28 and 42 are in their open circuit or “off” positions, as described above. The shield 46, typically a wall or barrier between first and second line switches 18 and 20, is made of any suitable non-conductive shielding material as is known in the art.

The switch assemblies 10 illustrated in FIGS. 1-3 have the “on” portion of each aligned switch 18 and 20 adjacent to one another and separated by the shield wall 46. With reference to FIGS. 4-6, another light switch assembly 12 is illustrated, the component parts thereof being numbered with the same reference number as the assembly 10 illustrated in FIGS. 1-3, but wherein the first and second line switches 18 and 20 are generally parallel to one another instead of end-to-end and having the shield 46 extending the length of each switch assembly 18 and 20. However, the switch assembly 12 operates in the same manner as that described above and provides the same benefits with respect to preventing sparks and magnetic induction of current.

The embodiments illustrated in FIGS. 1-6 are directed to switch assemblies 10 and 12 which are disposed within a power cord, established as a wall switch, or even a switch within the device itself. With reference now to FIGS. 7-9, a switch assembly 14 is illustrated which can be plugged into any existing outlet 48 by means of an electrical plug 50 having prongs, or any other such electrical connection means. The assembly 14 otherwise includes the housing 16 defining an internal compartment housing the first and second line switches 18 and 20 which can be operably connected to a main switch 44 moved between the “off” and “on” positions, as described above. However, the housing 16 includes an electrical outlet 52 built therein and electrically coupled to the first and second line switches 18 and 20 and adapted for reception of a plug 54, or other connector, of the electrical power consuming device. Thus, the assembly 14 is electrically connected to a power source, such as plugging the assembly 14 into a wall outlet or the like. An electrical cord of a power consuming device having a plug 54 or other electrical connection means is electrically coupled to the assembly 14 by inserting the plug 54 into the outlet 52 of the housing 16.

The main switch 44 is then turned from an “off” position, as illustrated in FIG. 7, to an “on” position, as illustrated in FIG. 9. Due to the mechanical means interconnecting the main switch 44 and the switch elements 34 and 36 of the first and second line switches 18 and 20, the first and second line switches 18 and 20 are moved from an open circuit “off” position to a closed circuit “on” position to provide power to the electrical device. This is done in a staggered, non-simultaneous manner as described above. Thus, existing wall outlets and electrical devices can be retrofitted or used as is while still implementing the present invention. The magnetic shielding wall 46 extending between the first and second line switches 18 and 20 is preferably incorporated in this assembly 14 as well to prevent the magnetic induction of current and waste of energy.

It will be appreciated by those skilled in the art that the present invention provides many advantages over current electrical switches. Due to the staggered, non-simultaneous opening and closing of the electrical switches 18 and 20, sparks are avoided. The use of a magnetic shield 46 prevents magnetic induction of current and unnecessary waste of energy.

Although several embodiments of the present invention have been described in detail for purposes of illustration, various modifications of each may be made without departing from the spirit and scope of the invention. Accordingly, the invention is not to be limited, except as by the appended claims.

What is claimed is:

1. A switch assembly for an alternating current electric circuit having a first line and a second line, comprising:
a first line switch conductively coupled to two separate portions of the first line and movable between an open circuit position and a closed circuit position, including a first connector for connecting the first line switch to a first portion of the first line which is, in turn, connected to a power source, and a second connector for connecting the first line switch to a second portion of the first line which is, in turn, connected to a power consumer, wherein said first and second portions of the first line are electrically connected when the first line switch is in said closed circuit position and not electrically connected when the first line switch is in said open circuit position; and
a second line switch conductively coupled to two separate portions of the second line and movable between an open circuit position and a closed circuit position, including a first connector for connecting the second line switch to a first portion of the second line which is, in turn, connected to a power source, and a second connector for connecting the second line switch to a second portion of the second line which is, in turn, connected to a power consumer, wherein said first and second portions of the second line are electrically connected when the second line switch is in said closed circuit position and not electrically connected when the second line switch is in said open circuit position;
wherein the first line switch and the second line switch are adapted so as to not to be moved into their closed circuit positions simultaneously to avoid harmful sparks.

2. The switch assembly of claim 1, further including a shield between said first line switch and said second line switch for preventing magnetic induction of current.

3. The switch assembly of claim 1, further comprising a means for connecting said first and second line switches to each other such that when the second line switch is moved into its closed circuit position, the first line switch is subsequently moved into its closed circuit position.

4. The switch assembly of claim 3, further comprising means for connecting said first and second line switches to each other such that when the second line switch is moved into its open circuit position, the first line switch is subsequently moved into its open circuit position.

5. The switch assembly of claim 3, wherein the connecting means comprises a mechanical means.

6. The switch assembly of claim 1, further comprising a means for connecting said first and second line switches to each other such that when the first line switch is moved into its closed circuit position, the second line switch is subsequently moved into its closed circuit position.

7. The switch assembly of claim 6, further comprising means for connecting said first and second line switches to each other such that when the first line switch is moved into its open circuit position, the second line switch is subsequently moved into its open circuit position.

8. The switch assembly of claim 7, wherein the connecting means comprises a mechanical means.

9. The switch assembly of claim 1, further including a compartment comprising a first line switch portion and a second line switch portion wherein said first line switch is located within said first line switch portion and said second line switch is located within said second line switch portion.

10. A switch assembly for an alternating current electric circuit having a first line and a second line, comprising:
a main switch movable between an open circuit position and a closed circuit position;
a first line switch operably connected to the main switch and conductively coupled to two separate portions of the first line and movable between an open circuit position and a closed circuit position, including a first connector for connecting the first line switch to a first portion of said first line which is, in turn, connected to a power source, and a second connector for connecting the first line switch to a second portion of the first line which is, in turn, connected to a power consumer, wherein said first and second portions of the first line are electrically connected when the first line switch is in said closed circuit position and not electrically connected when the first line switch is in said open circuit position;
a second line switch operably connected to the main switch and conductively coupled to two separate portions of the second line and movable between an open circuit position and a closed circuit position, including a first connector for connecting the second line switch to a first portion of the second line which is, in turn, connected to a power source, and a second connector for connecting the second line switch to a second portion of the second line which is, in turn, connected to a power consumer, wherein said first and second portions of the second line are electrically connected when the second line switch is in said closed circuit position and not electrically connected when the second line switch is in said open circuit position; and
a compartment comprising a first line switch portion and a second line switch portion wherein said first line switch is located within said first line switch portion and said second line switch is located within said second line switch portion;
wherein the first line switch and the second line switch are adapted so as to not to be moved simultaneously into their closed circuit positions to avoid harmful sparks.

11. The electrical switch assembly of claim 10, further including a shield between said first line switch portion and said second line switch portion for preventing magnetic induction of current.

12. The switch assembly of claim 10, further comprising a means for connecting said first and second line switches to each other such that when the second line switch is moved into its closed circuit position, the first line switch is subsequently moved into its closed circuit position, and when the second line switch is moved into its open circuit position, the first line switch is subsequently moved into its open circuit position.

13. The switch assembly of claim 12, wherein the connecting means comprises a mechanical means.

14. The switch assembly of claim 10, further comprising a means for connecting said first and second line switches to each other such that when the first line switch is moved into its closed circuit position, the second line switch is subsequently moved into its closed circuit position, and when the first line switch is moved into its open circuit position, the second line switch is subsequently moved into its open circuit position.

15. The switch assembly of claim 14, wherein the connecting means comprises a mechanical means.

16. A method for providing alternating current electric power to a power consuming device electrically connected to a switch assembly that is, in turn, electrically connected to first and second lines of a power source, comprising the steps of:
moving a first line switch and a second line switch of the switch assembly from open circuit positions to closed circuit positions in a non-simultaneous manner to complete the electrical circuit between the power consuming device and the source of power while avoiding harmful sparks.

17. The method of claim 16, including the step of magnetically shielding the first line switch from the second line switch.

18. The method of claim 16, including the step of electrically connecting a main switch to the first line switch and the second line switch and providing means for moving the first line switch and second line switch into their closed circuit positions in a non-simultaneous manner as the main switch is moved to a closed circuit position.

19. The method of claim 18, including the step of providing means for moving the first line switch and second line switch into open circuit positions in a non-simultaneous manner as the main switch is moved to an open circuit position.
